(19) United States
(12) Patent Application Publication
(10) Pub. No.: US 2005/0202177 A1
(43) Pub. Date: Sep. 15, 2005

(54) Machine and method for making a rotogravure printing medium

(76) Inventors: W. Richard Chesnut, Essex Fells, NJ (US); David Bressler, Long Valley, NJ (US); Daniel Calligaro, Little Falls, NJ (US)

Correspondence Address: Thomas L. Adams, 120 Eagle Rock Avenue, P.O. Box 340, East Hanover, NJ, 07936, US

(21) Appl. No.: 10/768,557

(22) Filed: Jan. 30, 2004

Related U.S. Application Data
(63) Continuation of application No. 09/950,357, filed on Sep. 11, 2001, now abandoned.

(51) Int. Cl. B05D 3/02

(52) U.S. Cl. 427/379; 118/620; 118/641; 118/668

(57) ABSTRACT

A machine can deposit a film on a roll that will be used as a rotogravure printing medium. The machine has a carriage for rotatably holding the roll. Also included is a rotary driver for rotating the roll, and a linear driver for moving the carriage downstream along a processing path in order to move the roll axially. The machine also has a coating head with an orifice that is in communication with a source of composition for dispensing the composition onto the roll helically as a merging series of adjacent, self-leveling strip or bead portions. The carriage can be moved to one or more curing stations where the composition film will be (a) initially cured with a UV energy source at a primary energy flux density, and (b) secondarily cured with a UV energy source at a secondary energy flux density that is greater than the primary energy flux density.

### BACKGROUND OF THE INVENTION

1. Field of the Invention

The present invention relates to a machine and method for making a rotogravure printing medium and more particularly, to applying a plastic printing medium to a printing roll or other workpiece, which is employed in rotogravure printing.

2. Description of Related Art

Rotogravure printing is a generally conventional method of printing on a sheet, web, or other substrate. The substrate may be a coated, uncoated, or metallized paper; glassine; plastic films and sheets made from vinyl, cellulose, acetate, polyester and polyethylene; plastic shrink films; paperboard; aluminum foil; fabrics; and similar materials. Rotogravure printing is capable of reproducing both subtle shades of color and black and white, and is particularly well suited for printing great numbers of copies precisely and rapidly. Typical end products for the printed substrates include labels, cartons, paper and plastic cups, trading stamps, wrapping paper, and sheet vinyl flooring.

Rotogravure printing is the only commercial printing process which can control both ink thickness and the area of ink coverage. This is achieved by etching or engraving recessed microscopic wells, frequently referred to as “cells,” of varying depth and area in a printing medium or image carrier surface. In controlling the size and depth of the cells, the amount of ink available for placement on the substrate is controlled to generate an image composed of an arrangement of large and small dots. Other types of printing, such as flexographic printing, are generally similar to rotogravure printing, but are specifically different, e.g., as to thickness of the printing medium and the character and formation of ink-transferring surfaces.

In typical rotogravure printing, the printing medium or image carrier is a copper film electro-deposited from a chemical bath on a specially prepared steel roll or cylinder. U.S. Pat. Nos. 5,694,852 and 6,136,375 and pending U.S. patent application Ser. No. 09/678,470 (filed Oct. 3, 2000), which are incorporated herein by reference, describe coating a surface by any method including helically depositing a beads or strip of curable plastic material onto a printing roll or cylinder. This coating, upon application, preferably has a thickness of from about 0.003″ to about 0.015″, preferably from about 0.0032″ to about 0.0040″. Where the printing substrate is to be used for other types of printing; such as flexographic printing, thickness up to about 0.040″ or more. This method is capable of effecting the deposit of a uniform, continuous and engraveable or etchable film onto a printing roll or cylinder.

While satisfactory as far as they go, the above patents do not disclose apparatus and method that would be tailored for efficient manufacturing, by taking into account production line workflow, and efficient setup techniques.

### SUMMARY OF THE INVENTION

In accordance with the illustrative embodiments demonstrating features and advantages of the present invention, there is provided a machine for depositing a film on a roll that can be used as a rotogravure printing medium. The machine has a carriage for rotatably holding the roll. Also included is a rotary driver for rotating the roll, and a linear driver for moving the carriage downstream along a processing path in order to move said roll. The machine also has a coating head having an orifice in communication with a source of composition for dispensing the composition onto the roll as a merging series of adjacent, self-leveling strip or bead portions.

In accordance with another aspect of the invention a machine is provided for depositing a film on a member that can be used as a rotogravure printing medium. The machine has a carriage for holding the member, and a coating head for dispensing a composition onto the member. Also included is a curing means for (a) initially curing the composition film with an energy source at a primary energy flux density, and (b) secondarily curing the composition film with an energy source at a secondary energy flux density that is greater than the primary energy flux density. The carriage being translatable from the coating head toward the curing means.

In accordance with yet another aspect of the invention a method is provided for making a rotogravure printing medium which includes a member with a film coating that is selectively alterable to produce ink-retaining cells. The method includes the step of depositing on the surface of the member a composition film of irreversibly curable plastic composition which is engraveable after curing to produce ink-retaining cells. Another step is initially curing the composition film with an energy source at a primary energy flux density. The method also includes the step of secondarily curing the composition film with an energy source at a secondary energy flux density that is greater than the primary energy flux density.

In accordance with still yet another aspect of the invention a method employs a coating head for dispensing a composition on a roll in order to make a rotogravure printing medium which includes a film coating that is selectively alterable to produce ink-retaining cells. The method includes the step of positioning the roll at the coating head in order to dispense the composition onto the roll with the coating head. Another step is rotating the roll about its axis while translating the roll axially past the coating head. The method also includes the step of helically dispensing the composition onto the roll as a merging series of adjacent, self-leveling strip or bead portions. The adjacent strip or bead portions can merge and self-level at and after deposition to produce a uniform, continuous coating of the plastic composition.

By employing apparatus and methods of the foregoing type an improved production version machine can be used to efficiently produce a thin polymeric coating preferably on a cylindrical roll that can be processed and utilized, after engraving, as a rotogravure image carrier. The improvements provide the following benefits: Preferably, a continuous process can be achieved that allows for loading and unloading of finished rolls, while the machine is kept in operation. One can accommodate rolls of variable length and variable diameters. The preferred machine and method allows a coating head with an elliptical orifice to remain stationary while the roll or part moves past it. The preferred coating head can provide a continuous flow of a polymer liquid.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a side elevational view of a machine implementing a method in accordance with principles of the present invention;

FIG. 2 is a plan view of the machine of FIG. 1;

FIG. 3 is a side elevational view of a portion of the machine of FIG. 1;

FIG. 4 is a plan view of the machine portion of FIG. 3;

FIG. 5 is a sectional view taken along line A-A of FIG. 1;

FIG. 6 is a diagram showing components of the machine of FIG. 1 together with this schematic diagram of controllers for regulating the operational speed of various machine components;

FIG. 7 is an elevational view of the coating head of FIG. 1, showing a displaced position of the head in phantom;

FIG. 8 is a diagram of a portion of the coating head of FIG. 7 showing its pitching motion;

FIG. 9 is a front view of the coating head of FIG. 7;

FIG. 10 is an exploded view of the coating head of FIG. 9; and

FIG. 11 is an axial, sectional view of a modified version of the coating head of FIG. 7.

### DETAILED DESCRIPTION OF THE PREFERRED EMBODIMENTS

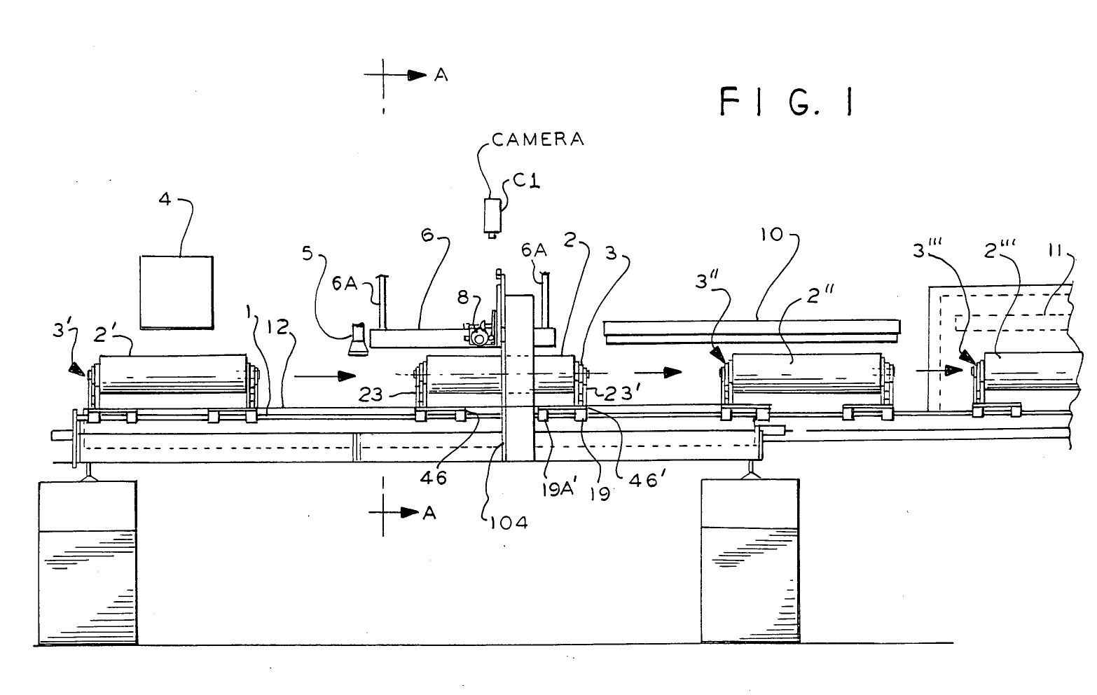

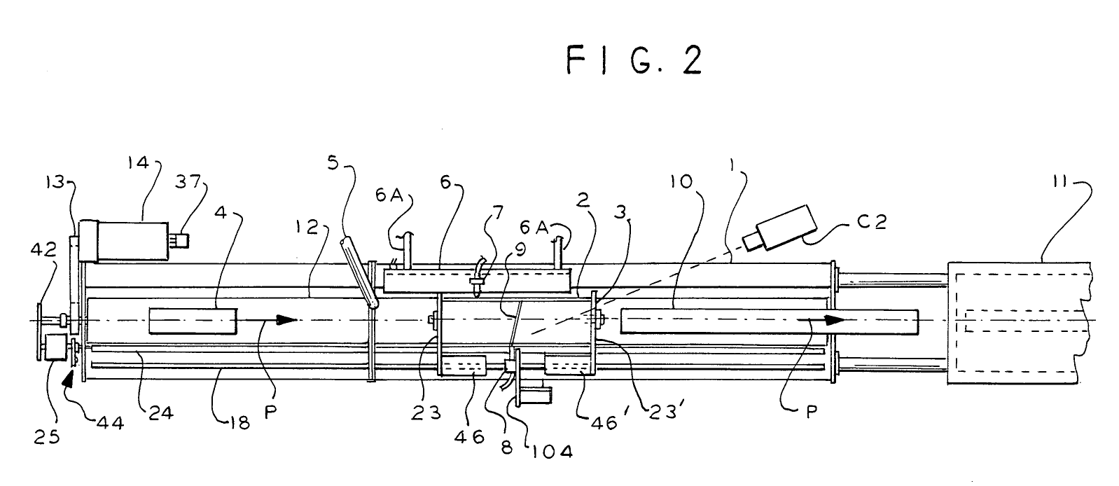

The machine is generally arranged as shown in FIGS. 1 and 2, which are respectively, a side elevation and plan view of the entire machine. The machine base 1 is supported from the floor at table level and consists of a heavy weldment consisting of two square tie-bars with end-plates. The length of the machine can be varied, however, about 12 feet is considered satisfactory.

The roll 2, is supported on a carriage 3, the design of which will be described hereinafter. The carriage assembly 3 containing the roll 2 is placed on the machine at the left-hand end (this view) and is caused to move to the right (downstream) and also caused to rotate in precise relationship to the rightward linear movement. The means to drive the roller in rotation, and also linearly in precise relationship will be described hereinafter.

As the roll 2 moves to the right from the left-hand side, it first enters a cleaning station 4, which consists of a source of ionized air (e.g., Chapman Static Eliminator model I-VSE 5000) followed by a vacuum cleaner nozzle 5 located at the top of the rotating roll. The ionized air flow causes any loose dust or dirt to be loosened from the roll surface by eliminating a static charge and the vacuum removes the loosened particles.

The roll 3, as it is vacuum cleaned, is also subjected to a heating system 6, consisting of a bar 6 with electric heaters, which is closely spaced to the surface of the roll 2 as it rotates to heat it by radiant and convective means. The heater bar 6 may have a V-shaped valley facing roll 2 to provide for more intimate heat transfer. Heater bar 6 is supported on adjustment struts 6A that allow adjustment of the spacing between roll 2 and bar 6. Struts 6A accommodate variations in the size of roll 2.

Heater 6 is sufficiently long to straddle coating head 8 and extend upstream (to the left) enough to heat the roll 2 to a temperature of a desired level, preferably in the range 100°-150° F. prior to reaching the coating head 8 (head described in further detail hereinafter). Also heater bar 6 has a length extending downstream (to the right) beyond coating head 8 to maintain this temperature for a period following the application of the coating by head 8.

Since the polymeric coating material is in the viscosity range of approximately 800 to 5,000 cP, the heat applied to the roller helps the material to “level out” on the roll surface immediately following its application. The level of heat can be thermostatically controlled via an optical or infrared sensor 7 that reads the roll surface temperature immediately prior to application of the coating. (Temperature control can be effected by, for example, an REX-D type controller from RKC Instrument Inc.) The properties of a suitable polymeric material is described in U.S. Pat. Nos. 5,694,852 and 6,136,375 and pending U.S. patent application Ser. No. 09/678,470 (filed Oct. 3, 2000) and as further refined hereinafter. Also coating head 8 has an elliptically shaped orifice similar to that described in that Patent.

In the present case the orifice, is mounted on a stationary structure, with adjustments in two directions to bring it in proximity to the surface of roll 2, as will be further described later. A polymer coating in liquid form is pumped through the orifice by a system to be described hereinafter, and is applied to the rotating surface of the roll 2 which generates a helical pattern noted as bead or strip 9 (pitch angle exaggerated). The flow of the material can be interrupted and re-started at the beginning and end of each roll by stopping the pump (pump shown hereinafter).

As the plastic composition is being applied to the roll 2, drum 12 is rotated at a rate of from about 30 rpm to about 90 rpm, preferably at about 45 rpm. Preferably, the drum 12 has a surface velocity of from about 5.0 inches per second to about 35.0 inches per second, more preferably from about 7.5 inches per second to about 16.0 inches per second.

As the roll 2 continues to turn and translate in a downstream (left-to-right) direction, after a short distance the roll 2 enters a primary curing station 10, which consists of a variable-level UV lamp. This lamp is generally of a wattage level between 10 and 200 W, which causes the coating to partially “set” or cure. The reason for the low-level, primary energy flux density is to cause the material to solidify gradually so as not to craze the surface or produce an “orange peel” appearance, which is a common phenomenon when curing thick coatings. A higher intensity UV lamp would immediately harden the surface of the curable material to form a shell above a fluid layer. Thereafter, the underlying fluid layer would rapidly cure and collapse at non-uniform rates to cause dimpling or crazing that produces the orange-peel effect. The length of UV lamp 10 is sufficiently long to maintain the low-level UV-cure such that the polymer coating is exposed to the lamp for a period of 20 to 80 minutes as roll 2 processes downstream.

Following the primary UV cure station 10 the roll 2 then moves to a secondary UV cure station 11. In this station the linear drive from left to right may be disengaged and only the rotative drive is applied to the roll. The entire carriage remains stationary. The secondary UV cure station 11 consists of a high intensity UV curing lamp of approximately 200 to 600 watts per inch. This lamp is energized for a period of approximately 2 to 5 minutes and at a rotational speed of approximately ½ to 1 revolution per second which imparts enough secondary UV energy flux density to the coating to produce cross-linking of the polymer molecules.

Since the secondary UV cure station performs its function while the roll 2 is in a rotational pattern, this process could also be done off-line in a separate fixture that provides the rotational speed to the roll while the lamp is energized.

Finally, the process also involves a final post-cure operation, which consists of heating the entire roll coating in a furnace at approximately 300° to 400° F. for a period of 1 to 3 hours. This allows for the final cross-linking to produce a very hard durable surface.

In summary, this new apparatus is efficient in continuous production as it allows for multiple functions to be performed simultaneously, i.e. roll preparation and mounting on the carriage of a new roll, de-ionizing and vacuum cleaning, preheating, coating application, primary cure and final cure, all simultaneously without interruption to the flow of the machine. While continuous production line processing is preferred, in some embodiments the process may be broken up into discrete stages, where a roll is carried on a cart to conduct a successive stage. Such separation may be desirable for the secondary cure stage where high intensity UV may inadvertently and prematurely reach a roll before the coating or primary curing stage is completed. (The primary curing station and the subsequent secondary stage will nevertheless still operate together as a curing means.) The process will preferably be conducted in a clean room environment with clear plastic drapes surrounding a region of positive pressure.

Design Details

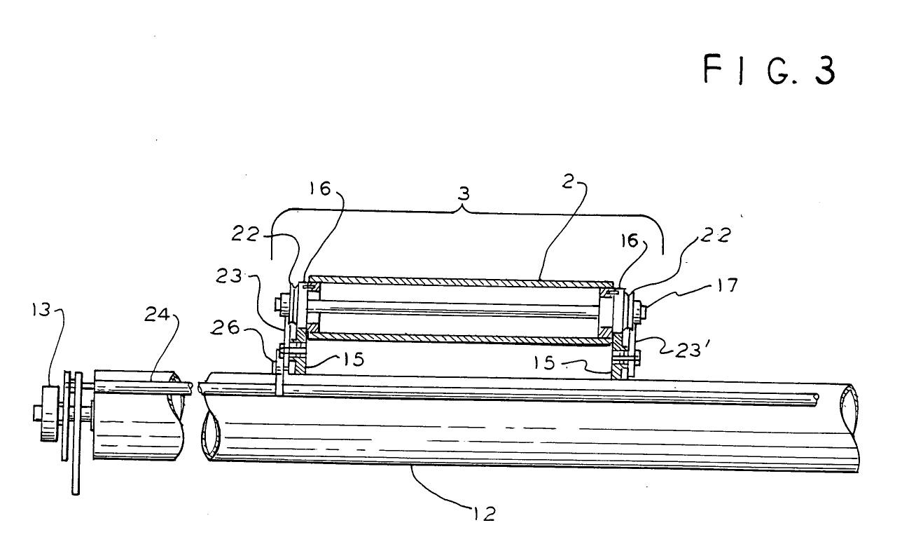

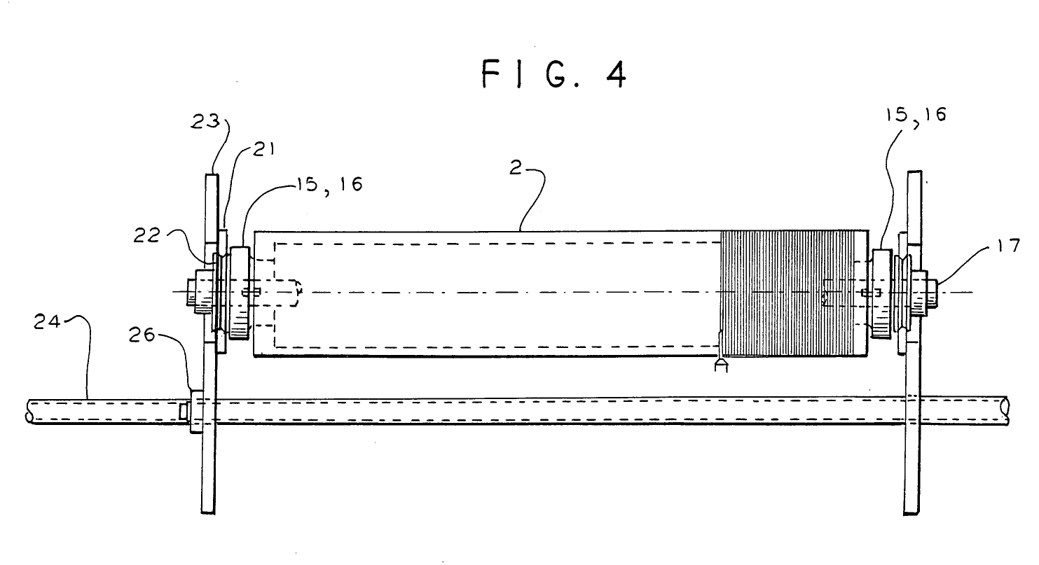

FIGS. 3, 4 and 5 show respectively a side elevation, plan view and end view of the carriage and drive assembly. Referring to these figures a rotary driver is shown therein as a precision machined drum 12 running the length of the machine and driven by an electric motor 14 and timing belt drive 13. Drum 12 is machined accurately on its journals and has a smooth surface on the outside diameter. The carriage 3 is partially supported on the drum 12 and is also driven in a rotational manner from the drum 12 by a series of bearers 15 and 16. Note that there are a set of bearers 15 and 16 located at each end of the roll 2. The bearers convey the rotative motion to a roll 2 as follows:

Each bearer 15 and 16 comprises a steel bearer wheel with a smooth OD. A bearer 16 is mounted to each end of the roll and is located by shaft 17. A pair of bearers 15 are separately mounted at each end of the carriage frames 23 and 23′ and are free turning on ball bearings and are held in contact with bearer 16 because of the weight of the roll 2 and shaft assembly (shaft 17 and associated structure). The precise positioning of the roll 2 and shaft structure 17 while it is driven is described hereinafter.

Also mounted to shaft 17 is a sheave type wheel 22 coaxially located adjacent to bearer 15 on each end of the shaft 17. This sheave 22 contains a ball bearing so it does not have to rotate with shaft 17. When loading the shaft assembly 17′ (shorthand notation for shaft 17, roll 2, bearers 16, and sheaves 22) vertically downward into slots provided in the carriage frames 23 and 23′, sheave 22 engages gibs 21 and 21′ located on each side of the slot for each end of the assembly.

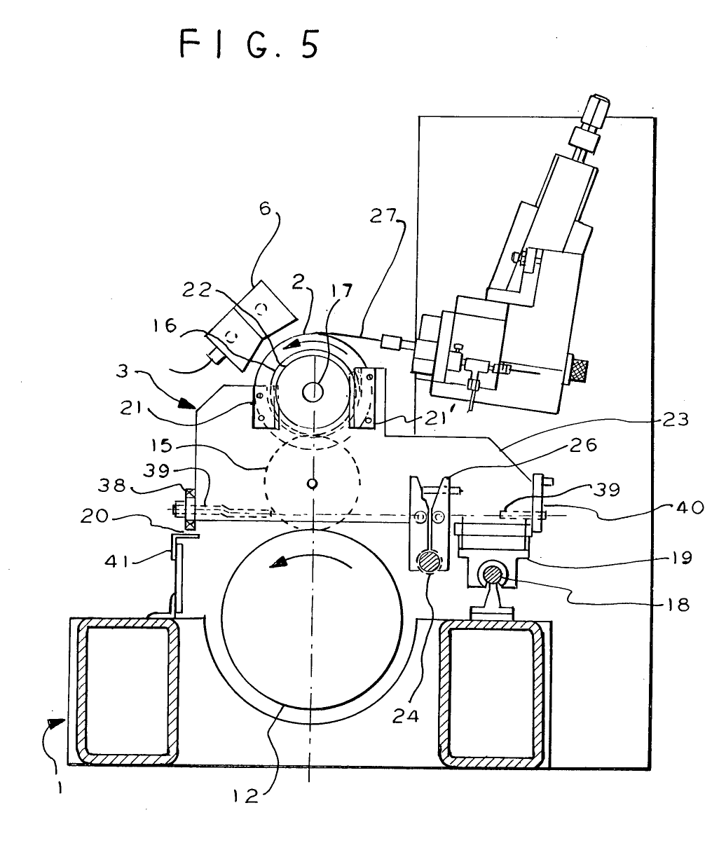

Gibs 21 and 21′ are pairs of plates with tapered vertical edges facing each other and designed to slide into the annular groove on the periphery of sheave 22. (Hereinafter gib 21 shall be deemed to refer to gib 21′ as well, unless the context indicates otherwise.) The function of the gibs 21 and sheave 22 is to provide precise horizontal positioning of roll 2 and shaft 17 without confining it in the vertical direction (when viewing FIG. 5).

The vertical positioning of the roll 2 and shaft assembly 17′ is determined by the contact of the bearers. 16 against bearers 15, which is rotatably mounted to the carriage side-frames 23 and 23′ as best viewed in FIG. 5 (Frames 23 and 23′ are also referred to herein as end supports) Finally, contact between end-bearers 15 and drum 12 is caused by the weight of the roll 2 and shaft assembly 17′ on bearer 15 so that, in turn, the entire mass is then pressed against drum 12, which ultimately determines the vertical positioning of shaft 17.

The horizontal positioning of the carriage assembly 3 is determined as follows: Referring to FIG. 5, the front (right side in this view) of each carriage frame 23 (and frame 23′) is supported on a beam 18 and linear ball bushing structure 19 (e.g., Thompson type bearing). This determines the horizontal and vertical location of one side of the carriage frame 23 while allowing slight rotational motion of the entire carriage structure 3 about beam 18. The final rotational positioning of the carriage 3 is determined by the contact of bearers 15 against drum 12, wherein the structure is being forced generally downward against the drum 12 due to the weight of the combined parts, housed in carriage 3. This weight being sufficient to provide frictional traction between drum 12, bearer 15 through bearer 16, necessary to drive roll 2 and shaft 17 in a positive counter-clockwise direction when viewing FIG. 5.

Note that carriage frames 23 and 23′ located on each end of the shaft structure 17′ (as well as the ball bushings 19 mounted on each carriage frame) are independent of each other. The only connection between frames 23 and 23′ being the contact of sheave 22 against gibs 21 on each end of shaft 17. Thus, when carriage frames 23 and 23′ are caused to translate in a horizontal direction as viewed in FIG. 1, generally from left to right along the axis of drum 12, the spacing of carriage frames are maintained by sheaves 22 and gibs 21.

Frames 23 and 23′ are separately attached to independent platform frames 46 and 46′, respectively (FIGS. 1 and 2). Platform 46 has depending from it a pair of linear bearings 19 and 19A that are spaced to reinforce frame 23 from any tendency to rotate about a horizontal axis that is perpendicular to lead screw 24.

The linear movement of carriage 3 from left to right (downstream) is conveyed by means of a linear driver, shown as a lead screw 24, which is precisely rotated from a drive system connected to drum 12. The linear driver produces carriage motion in a downstream direction along a processing path P. This linear driver is powered through gear 42 (FIG. 2) mounted on the end of drum 12 for driving a gear reducer 25, the output of which travels through a set of change gears 44 to provide variance to the rotational speed of the lead screw with respect to drum 12.

In some embodiments reducer 25 may be a transmission having a discretely or continuously variable transmission ratio. Alternatively, gears in train 44 may be replaced to effectively produce a variable transmission ratio. In many embodiments a variable transmission ratio will be unnecessary if the size of roll 2 does not vary dramatically, in which case variations in roll size can be accounted for by varying the rate of deposition of composition by coating head 8, in a manner to be described presently.

Referring to FIGS. 3 and 5 on the trailing one of the carriage frames 23 is located a split nut 26 device, which can be manually engaged and disengaged from the lead screw 24. This split nut device 26 is similar to that described in U.S. Pat. No. 6,136,375. When split nut 26 is disengaged, carriage assembly 3 is no longer driven by lead screw 24.

In the beginning stages of preparing a roll 2 for coating as described above, a new roll 2 is mounted onto shaft 17 along with the bearers 16 and sheave 22 assemblies on each side of the roll 2. The entire assembly is then dropped into carriage frames 23 and 23′. The carriage frames 23 and 23′ are laterally positioned relative to each other by virtue of their engagement of sheaves 22 and gibs 21 on each end. The entire assembly is mounted on the left-hand side of the machine (FIG. 1) and slid to the right so ball-bushing 19 can engage rod 18, which runs the entire length of the machine.

As described earlier, bearer 15 then becomes engaged with drum 12, which commences the rotational operation of roll 2. To provide for disengagement at any time of the rotative drive to the roll 2, each carriage frame 23 (and 23′) is fitted with a lift wheel 38 which is mounted on eccentric shaft 39. By rotation of lever 40 on one end of shaft 39 by approximately 180°, the gap 20 is eliminated because wheel 38 contacts auxiliary rail 41, lifting bearer 15 out of contact with drumroll 12. If at the same time split nut 26 is disengaged from lead screw 24, frame 3 can be freely moved upstream and downstream, riding then on linear bearing 19 and wheel 38.

When the entire carriage assembly 3 is in the proximity of the ionizer cleaning station 4, split nut 26 is manually engaged to lead screw 24. The linear motion of the carriage 3 from left to right (downstream) is now commenced as roll 2 with shaft 17 are now rotated and driven linearly from left to right in precise relationship. More than one carriage assembly 3 containing a roll can be introduced to the machine at one time from the left hand end. In fact, normal operation would allow for a carriage 3′ and roll 2′ (FIG. 1) to be introduced to the left hand side of the machine to the cleaning section 4, while another carriage unit 3 containing a roll 2 is being coated, while another carriage 3″ and roll unit 2″ is undergoing primary UV cure and yet another roll 2′″ and carriage assembly 3′″ is undergoing secondary UV cure under UV source 11 at the illustrated secondary curing station, which really exhibits the in-line continuous nature of the machine.

Ultimately, Simultaneously by disengaging split-nut 26 as described above, the entire carriage can now be freely moved manually along the machine bed. Specifically, roll 2′″ and carriage 3′″ can be removed from the machine so that roll 2′″ can be separated from carriage 3′″ and subjected to final heat curing. Carriage 3′″ can then be recycled by placing it at the upstream end of the machine and loading on it a new roll for processing in the manner just described.

Details of Elliptical Orifice and Polymeric Pumping System

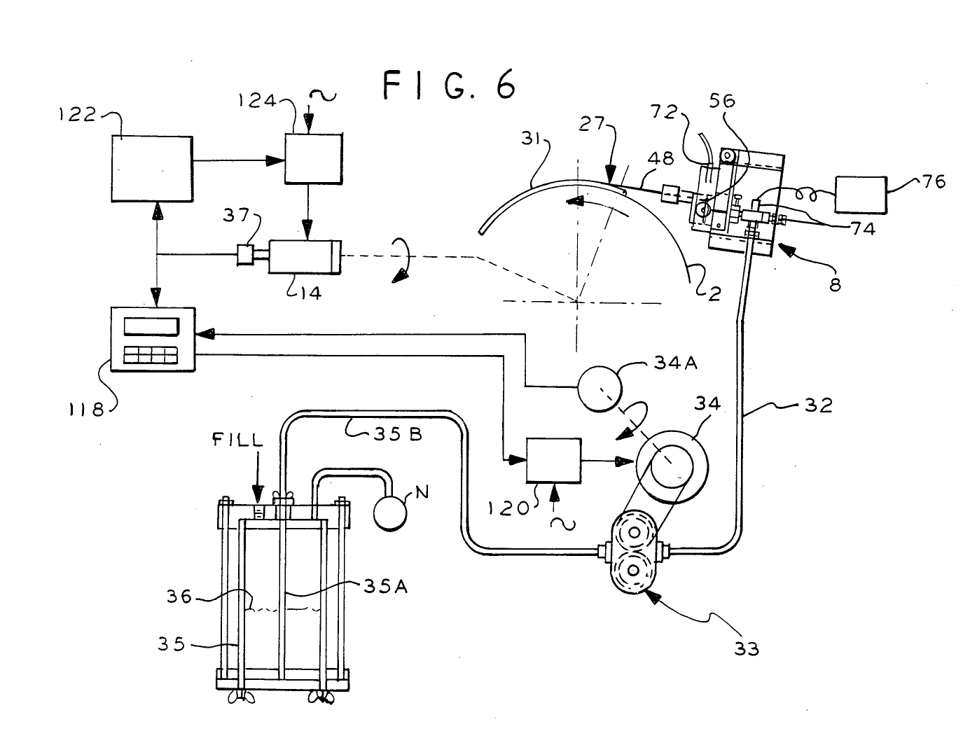

FIGS. 6, 10, and 11 show further details of the orifice and method to convey the polymeric liquid precisely to coat a roll. Orifice 27 is positioned in close proximity to surface of roll 2 as noted in FIG. 6.

Referring to FIG. 11, orifice 27 is the opening at the distal end of a thin metal tube 48 that is much like a hypodermic needle. Tube 48 may be built in accordance with U.S. Pat. Nos. 5,694,852 and 6,136,375 and pending U.S. patent application Ser. No. 09/678,470 (filed Oct. 3, 2000). Specifically, tube 48 has a cylindrical central bore and its distal end is cut at an angle so that orifice 27 has an elliptical rim.

The diameter of the bore, and the minor axis of the elliptical orifice, when viewed normally to the plane thereof, is about 0.010″ to about 0.055″, and is preferably about 0.030″. The major axis of the elliptical orifice, when viewed normally to the plane thereof, is about 4 to 8 times larger than the minor axis, that is, about 0.040″ to about 0.440″, and is preferably about 0.120″ to about 0.240″.

Tube 48 is coaxially mounted in a tubular barrel 50 that is threaded into an annular plug 52. The proximal side of plug 52 has a conical cavity 54 that is overlaid with a filter assembly 56. While shown coaxially mounted in the simplified embodiment of FIG. 11, in other embodiments barrel 50 may be eccentrically mounted in plug 52, leaving the floor of cavity 54 free for a center stud (e.g., a screw—not shown) to support the center of filter assembly 56. Filter assembly 56 may employ a filter substrate juxtaposed on a reinforcing metal screen for additional support. Plug 52 is threaded into rotor 58 to capture filter assembly 56.

An integral, cylindrical journal 58A extending behind rotor 58 is rotatably mounted in support block 60. A control plate 62 is bolted to journal 58A for rotating rotor 58 and thereby turning needle 48 about its axis. A fitting 64 is inserted through a hole in control plate 62 and is threaded into journal 58A. A probe fitting 66 is threaded in turn into fitting 64 to provide fluid communication from supply tubing 68 through fittings 66 and 64 through a passage in rotor 58 leading to conical cavity 58B.

Temperature sensor 70 is installed in the back of fitting 66 and extends through fittings 66 and 64 into conical cavity 58B in order to sense the temperature of material about to the flow out of orifice 27. Temperature sensor 70 may operate through a temperature controller (for example, a REX-D type of controller manufactured by RKC Instrument Inc.) to regulate an electrical heater 72 installed on rotor 58.

A pressure sensor 74 installed atop a port of fitting 66 will send an electrical signal to display panel 76 to allow an operator to monitor the back pressure of material supplied by tubing 68. This back pressure signal can indicate a problem due to clogging of filter 56 or high material viscosity caused by inadequate heating from heater 72.

Rotor 58 can be rotated by turning control plate 62. To accomplish such rotation, the upper end of plate 62 is attached to a horizontally movable adjustment shuttle bar 78, which will be described further hereinafter.

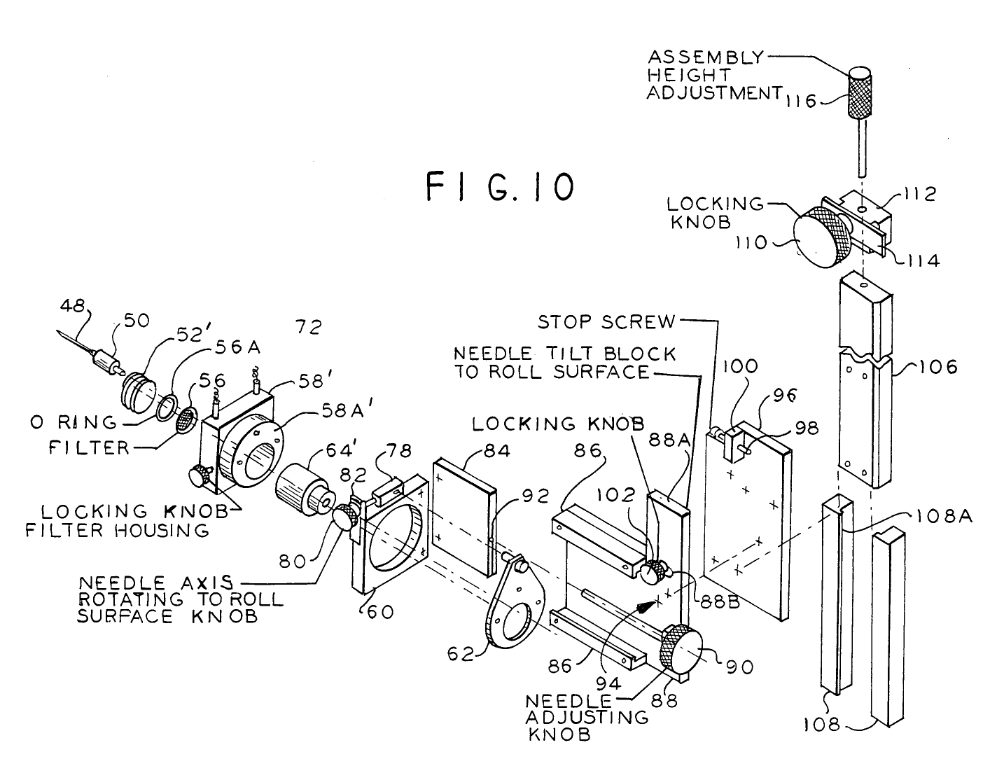

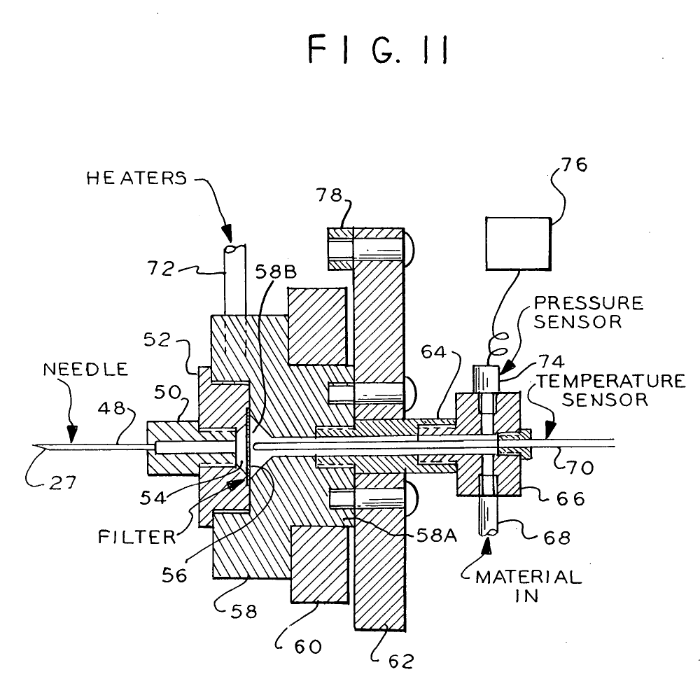

Referring to FIG. 10, components previously illustrated in FIG. 11 bear the same reference numerals, with similar but modified components marked with a distinguishing prime (′). Previously mentioned needle 48 will be threaded by means of its barrel 50 into a modified plug 52′. Barrel 50 will be threaded into an eccentric position. Filter assembly 56 is shown cooperating with an “O” ring 56A. Rotor 58′ is shown as a rectangular block having a cylindrical journal 58A′. Fitting 64′ will be installed in an eccentric position in journal 58A′. The eccentric mountings of fitting 64′ and barrel 50 offset each other so that needle 48 is coaxial with journal 58A′.

Journal 58A′ is rotatably mounted in block 60, a rectangular block with a relatively large central opening. Previously mentioned control plate 62 is attached to journal 58A′ and its upper end is bolted to previously mentioned adjustment block 78. Block 78 is attached to the threaded shaft of adjustment knob 80, which is rotatably mounted in bracket 82 attached to the outside of block 60. By rotating adjustment knob 80, plate 62 can rotate rotor 58′ to cause needle 48 to rotate about its axis. This adjustment is discrete, in the sense that the needle just rotates about its axis (roll), without disturbing any of its other positional coordinates. (elevation and two dimensional horizontal location).

Block 60 is attached to slide plate 84, which is slidably mounted between rails 86 on pitch plate 88. Rotatably mounted on plate 88 is an adjustment knob 90 whose threaded shaft engages threaded bore 92 in slide plate 84. Rotation of knob 90 slides plate 84, causing needle 48 to move axially.

Pitch plate 88 is attached at pivot point 94 to base plate 96. Due to the weighting about pivot point 94, tab 88A of pitch plate 88 normally swings counter-clockwise against the inside end of stop screw 98, which is threadably mounted in block 100 attached to base plate 96. Adjustment of stop screw 98 can swing pitch plate 88 about pivot point 94 to change the pitch or angle of elevation of needle 48. Pitch plate 88 can be locked into position by turning the threaded locking knob 102, which fastens plate 88 to base plate 96 through arcuate slot 88B.

Slider 106 supports base plate 96 and slides along an adjustment path between rails 108, which are attached to upright 104 (FIG. 1). Threaded locking knob 110 is threaded into backer block 112, which rides behind ridges 108A of rails 108. Locking cross plate 114 rides over ridges 108A and can be tightened by locking knob 110 to squeeze ridges 108A between elements 112 and 114, locking them onto rails 108. Threaded height adjustment knob 116 non-threadably passes through block 112 and screws into slider 106. Accordingly, rotation of knob 116 can lift and lower slider 106 between rails 108.

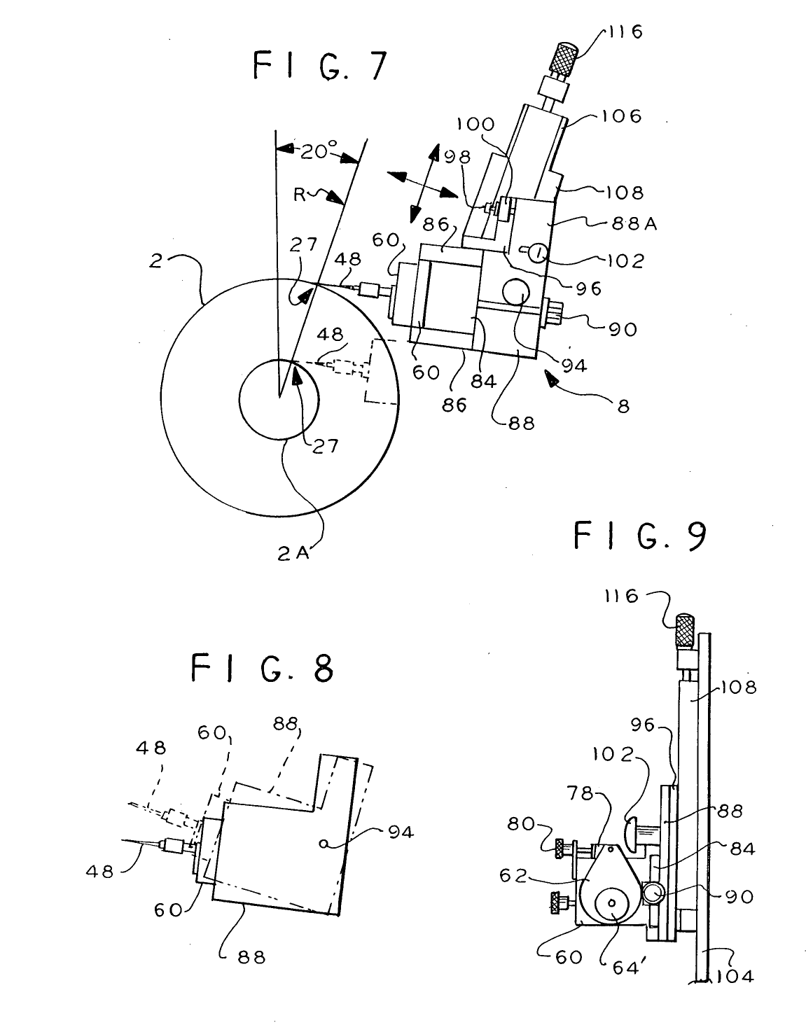

Referring to FIG. 7, coating head 8 is shown with the tip of needle 48 at the circumference of roll 2. Needle 48 is also shown in phantom repositioned to accommodate a smaller roll 2A. When being adjusted to accommodate different size rolls, the orifice 27 at the tip of needle 48 follows a discrete adjustment path R that is radial with respect to roll 2 and that is at an acute angle to vertical; suitably, 200 (although various other angles can be used instead). This repositioning to accommodate different size rolls is accomplished simply by adjusting the position of slider 106, which also follows a 200 inclined path. This adjustment is discrete, in the sense that the needle just translates along a path without disturbing any of its other angular coordinates (pitch, roll, or yaw). (It will be appreciated that slider 106 is given in a simplified form without the block 112 of FIG. 10, for illustrative purposes.)

It will be further appreciated that the other needle adjustments described presently need not be readjusted to compensate for a new roll size. These other adjustments establish the pitch and roll of the axis of needle 48 and the axial position of needle 48 relative to radial track R. These ordinarily remain unchanged if the needle is readjusted for roll size.

Referring again to FIG. 7, the axial extension of needle 48 can be adjusted by turning knob 90 to rotate its shaft and move slide block 84 between rails 86. This adjustment is made to place the center of elliptical orifice 27 on radial track R. The plane of the ellipse of orifice 27 is preferably kept tangential to the circumference of roll 2. By adjusting stop screw 98 and rotating pitch plate 88, tangency can be established by discretely adjusting the pitch of needle 48 about pivot 94. This pitch is held by clamping plate 88 in position by tightening locking knob 102. This pitching motion is illustrated in FIG. 8.

Finally, needle 48 can be rotated about its axis using the adjustments shown in FIG. 9. Adjustment knob 80 is rotated to shift block 78 and thereby rotate control plate 62. Since control plate 62 is bolted to rotor 58 (FIG. 11), the rotor and needle 48 will rotate about their axes.

These adjustments can be used to locate orifice 27 in contact with roll 2. Such light contact tends to avoid orifice-roll spacing problems. Specifically, attempts to produce a uniform coating with the tube 48 and its orifice 27 spaced from the roll 2 met with difficulty as non-circular rotation of the roll 2 led to varying spacings between the orifice 27 and the roll 2. These varying spacings affected the uniformity of the cured coating. With at least a portion of the tube 48 contacting and riding on the roll 2 at all times, the orifice 27 is maintained in a fixed spatial relationship relative thereof.

The adjustment of needle 48 is facilitated by overhead camera C1 (FIG. 1) and side camera C2 (FIG. 2). These cameras may be fitted with telephoto (or in some cases macro) lenses to provide close-up views of the orifice 27.

Referring to FIG. 6, tubular needle 48 is clamped into position on coating head 8 and so its internal passageway can be used to feed polymer material from pipe 32. The material is pumped through this passageway and out the internal orifice 27 to form coating 31, as the roll 2 rotates. Details of the coating material are noted below. The previously mentioned filter assembly 56 is shown located in head 8. Also,tubular electrical heater elements 72 located on head 8 are, by virtue of the aluminum construction of head 8, able to convey heat to the polymeric material as it passes through the housing. As previously mentioned, this heater is thermostatically controlled. (Temperature control can be effected by, for example, an REX-D type controller from RKC Instrument Inc.)

A precision gear-type pump 33 driven from a digital drive system includes a motor 34 with shaft encoder 34A. A digital drive controller 118 is shown connected and responsive to the output of shaft encoder 34A in order to send a control signal to a power modulator 120 that regulates the electrical drive and therefore the speed of motor 34. In some cases motor 34 may be a stepper motor whose shaft position is digitally incremented by controller 118. In other embodiments motor 34 may be a DC motor whose speed is regulated in the usual manner.

Drive controller 118 is connected to previously mentioned shaft encoder 37 for sensing the precise rotational speed of motor 14, which directly drives roll 2. Accordingly, controller 118 responds to the angular speed of roll 2 and commands supply 120 to drive motor 34 at a speed bearing a precise ratio to the angular speed of roll 2. The method of controlling precise speeds of two independently rotating elements using a digital drive with a shaft encoder located on each rotational element as a reference is a common method of speed control. For example such ratio control can be accomplished by an MDC type motor controller manufactured by Red Lion Controls, York, Pa. and Berkshire, England.

The operating speed of the system is determined by setting first the speed of motor 14 and therefore the angular speed of roll 2. Specifically, motor controller 122 starts motor 14 and then senses its angular speed via shaft encoder 37. The speed is regulated by sending a speed control signal to the power modulator 124, which drives main motor 14. In some embodiments, controller 122 may be a relatively simple feedback system offering a knob or dial for adjusting the speed of motor 14.

Once the speed of motor 14 is established, controller 118 establishes the speed ratio between roll 2 and material pump 33. An operator can adjust this ratio by using the display and keys on controller 118, basing the ratio on the roll size, the desired coating thickness, material density and viscosity, etc. Also as mentioned previously, the linear speed of the carriage 3 carrying roll 2 is determined by the drive ratio of the reducer 25 and gear train 44 (FIG. 2). In some embodiments this drive train may include a transmission for adjusting this drive ratio discretely or continuously.

Consequently, the drum rotates and moves linearly at a precise ratio that is proportional to the rate of composition pumped through orifice 27 by means of metering pump 33. The plastic composition, when applied to the printing roll or cylinder, has a viscosity of from about 800 cP to about 5,000 cP, the viscosity preferably being from about 1,000 cP to about 2,000 cP. The plastic composition is applied at a pressure of from about 8 psi to about 60 psi, preferably at about 30 psi. This pressure can be measured by sensor 74 and displayed on monitor 76.

The printing roll 2 may be of a standard size, for example, it may have a diameter of about 361 mm, and be rotated at speeds of about 30 to about 90 rpm, with about 45 rpm being preferred. The tube 48 and its orifice 27 are moved along the rotating roll's surface at a rate of from about 0.008″ per revolution to about 0.048″ per revolution, with about 0.0192″ per revolution being preferred.

The orifice area, the viscosity of the plastic composition, the pressure at which the plastic composition is applied, the cylinder rotational speed, and the rate of movement of the tube and orifice across the cylinder surface are adjusted such that when the plastic composition is applied to the printing roll or cylinder, the thickness of the plastic composition deposited upon the cylinder is from about 0.003″ to about 0.015″, preferably from about 0.0032″ to about 0.0035″, and most preferably at about 0.0040″. The plastic composition preferably is applied to the printing roll or cylinder at room temperature (about 23° C.), while the printing roll or cylinder, prior to application of the plastic composition, may be preheated to a temperature of from about 23° C. to about 40° C., preferably to about 30° C.

Preferably, the plastic is dispensed at a rate of from about 0.035 cc to about 0.155 cc per revolution of cylinder 12. To produce the preferred 0.0035″ thick composition film, tubes 48 having bores with 0.010″, 0.023″ or 0.053″ diameters (and ellipse minor axes) were used and were moved across the surface of the rotating roll 2 at respective rates of 0.008-0.010″ per revolution, 0.019-0.021″ per revolution, and 0.040″-0.048″ per revolution. These dimensions also represent the approximate center-to-center spacing of the adjacent runs or portion of the strip or bead when tubes 48 with the illustrative bore sizes are used.

The polymeric material 36 is supplied from reservoir 35 (referred to herein as a source of composition), which contains a suction tube 35A connected via tubing 35B to the input of pump 33. The polymeric material 36 can be periodically replaced in reservoir 35 while the system is operating through an opening in the top of the reservoir. The flow of composition 36 from reservoir 35 is boosted by a source N of compressed nitrogen gas.

Generally the generation of the coating is in helical form and the build up of the coated surface is described thoroughly in U.S. Pat. Nos. 5,694,852 and 6,136,375 and pending U.S. patent application Ser. No. 09/678,470 (filed Oct. 3, 2000). Also the general mounting of needle 48 is shown in that patent with the exception of the improvement shown in FIG. 7 and elsewhere. In particular, the present coating head 8 is carried on a slide that is mounted on an angle (of approximately 20°), such that the entire assembly can be translationally adjusted so that the orifice tip 27 moves in a radial direction toward the center line of roll 2. Similarly the perpendicular motion “in-out” can also be by a second slide assembly of similar nature.

Finally pivot 94 (FIG. 8) provides for throw-off of the elliptical orifice 27, during periods of set up. This is beneficial since the upward tilt of the orifice assembly facilitates the bleeding of air from the passages.

Details of the Liquid Polymer

The plastic composition has a preferred viscosity of about 2,000 CPS to 40,000 CPS, preferably from about 2,000 CPS to 5,000 CPS. Possible compounds include plastic compositions which include one or more epoxide resins (e.g., cycloaliphatic epoxides or amine-based epoxides), vinyl esters formed from an epoxy-novolac compound, bisphenol A epoxy resins modified with cresol novolac§), cycloaliphatic or amine based epoxide resins, epoxy resins which are the reaction product of epichlorohydrin and bisphenol A, and mixtures of expanding polycyclic monomers. As a result, as is known, these compositions are irreversibly cured. To these compositions there may be added, as appropriate, flexibilizers, photoinitiators, surfactants, slip agents, modifiers, dyes, additional epoxy resins, catalysts, promoters and accelerators. The compositions, once cured, are engraveable or etchable to produce printing cells or elevated printing surfaces.

The preferred composition is self-leveling, UV curable, formed from a liquid Epoxy-Novolac resin compound. In an ultraviolet cured Epoxy-Novolac system, the plastic composition would include products of reactions of Phenol(s) or Cresol(s) with Formaldehyde(s) such as Orthocresol Formaldehyde, the UV system may further include flexibilizing components, a photoinitiator component, a surfactant and a dye.

Optional flexibilizing components may include, but are not limited to, Polyols, Diols, Triols and Activated Polyolefins. Examples of photoinitiators which may be employed, include, but are not limited to, Triaryl or Triphenyl-Sulfonium Salts. Surfactants or surface modifiers which may be employed in the UV curable system, include, but are not limited to, Nonionic Fluoroaliphatic Polymer Ester surfactants and organomodified Polymethyl Siloxane Copolymers.

Dyes or near infrared absorption dyes that may be employed in the UV curing system include, but are not limited to, antimony compounds as Sb. An example of a near infrared absorption dye is sold as ADS1060A by ADS American Dye Source.

Obviously, many modifications and variations of the present invention are possible in light of the above teachings. It is therefore to be understood that within the scope of the appended claims, the invention may be practiced otherwise than as specifically described.

1. A machine for depositing a film on a roll that can be used as a rotogravure printing medium, comprising:
a carriage for rotatably holding said roll;
a rotary driver for rotating said roll;
a linear driver for moving said carriage downstream along a processing path in order to move said roll axially; and
a coating head having an orifice in communication with a source of composition for dispensing said composition onto said roll as a merging series of adjacent, self-leveling strip or bead portions.

2. A machine according to claim 1 comprising:
curing means for (a) initially curing said composition film with an energy source at a primary energy flux density, and (b) secondarily curing said composition film with an energy source at a secondary energy flux density that is greater than said primary energy flux density.

3. A machine according to claim 2 wherein said linear driver is operable to move said carriage along said processing path from said coating head to said curing means.

4. A machine according to claim 1 wherein said linear and said rotary driver are linked to work at dependent, proportional speeds.

5. A machine according to claim 1 comprising:
a heater positioned in proximity to said coating head in a position to heat said roll before receiving said composition from said coating head.

6. A machine according to claim 5 wherein said heater is elongate, and straddles and extends upstream of said coating head, so that said roll is preheated before and heated at said coating head.

7. A machine according to claim 6 comprising:
an infrared sensor coupled to said heater and located along said processing path to sense temperature of said roll and thermostatically regulate said heater.

8. A machine according to claim 5 wherein said linear driver is operable to move said carriage alongside said heater to said coating head.

9. A machine according to claim 5 comprising:
a primary curing station for initially curing said composition film with an energy source at a primary energy flux density, said linear driver being operable to move said carriage along said processing path from said heater, past said coating head to said primary curing station.

10. A machine according to claim 9 comprising:
a secondary curing station for secondarily curing said composition film with an energy source at a secondary energy flux density that is greater than said primary energy flux density, said linear driver being operable to move said carriage along said processing path from said heater, past said coating head and said primary curing station to said secondary curing station.

11. A machine according to claim 1 comprising:
a metering pump coupled to said source of composition for urging said composition through said orifice.

12. A machine according to claim 11 wherein said pump is driven in dependence on and in proportion to the angular speed of said rotary driver.

13. A machine according to claim 11 comprising:
a controller coupled to said either one of said rotary driver or said linear driver for sensing its operating speed, said controller being operable to drive said pump to operate in dependence on and in proportion to the operating speed, said controller being operable to adjust the proportionality between the speed of said pump and said operating speed.

14. A machine according to claim 11 comprising:
a source of compressed gas coupled to said source of composition for urging said composition through said metering pump.

15. A machine according to claim 1 wherein said coating head is adjustable to move said orifice along a discrete adjustment path that is radial relative to said roll.

16. A machine according to claim 15 wherein said adjustment path extends at an acute angle to vertical.

17. A machine according to claim 15 wherein said coating head has a tubular needle, said coating head having discrete adjustments to adjust the pitch and roll of said tubular needle.

18. A machine according to claim 1 wherein said coating head comprises:
a slider that is linearly adjustable to move said orifice along an adjustment path that is radial relative to said roll.

19. A machine according to claim 1 wherein said coating head comprises:
a heater element for heating composition flowing through said coating head.

20. A machine according to claim 19 wherein said coating head comprises:
a temperature sensor for sensing the temperature of said composition in said coating head and thermostatically controlling said heater element.

21. A machine according to claim 1 comprising:
a filter between said source of composition and said orifice for filtering said composition.

22. A machine according to claim 1 wherein said coating head comprises:
a filter for filtering said composition.

23. A machine according to claim 22 wherein said coating head comprises:
a pressure sensor for sensing and displaying information about the pressure of said composition in said coating head.

24. A machine according to claim 1 wherein said rotary driver comprises:
a drum extending axially along said processing path, said carriage having a bearer for bearing on said drum, said bearer being arranged to be driven by said drum in order to rotate said roll.

25. A machine according to claim 24 wherein said bearer comprises:
a bearer wheel rotatably mounted on said carriage to be driven by said drum in order to rotate said roll.

26. A machine according to claim 24 wherein said carriage comprises:
a pair of end supports independently riding on said drum, so that the spacing between said end supports is alterable to accommodate said roll.

27. A machine according to claim 26 wherein said bearer comprises:
a pair of bearer wheels rotatably mounted on different corresponding ones of said end supports to be driven by said drum in order to rotate said roll, said carriage being at least partially supported by said bearer wheels.

28. A machine according to claim 27 comprising:
a beam extending along said processing path, each of said end supports having a linear bearing riding said beam, said linear bearing being on an opposite side of said processing path than said bearer.

29. A machine according to claim 28 wherein said linear driver comprises:
a lead screw, said carriage having a nut releasably connected to said lead screw.

30. A machine according to claim 26 wherein each of said end supports comprises:
a spaced pair of gibs, said roll having on each end a sheave sized to fit between said gibs.

31. A machine according to claim 30 including an auxiliary rail located alongside said processing path, said carriage comprising:
a retractable lift wheel sized to ride on said auxiliary rail and lift said bearer, said lift wheel being manually retractable to place said bearer on said drum.

32. A machine according to claim 1 comprising:
a source of ionized air located upstream of said coating head for directing ionized air at the roll.

33. A machine according to claim 32 comprising:
a vacuum cleaner located between said source of ionized air and said coating head for removing particles from said roll.

34. A machine for depositing a film on a member that can be used as a rotogravure printing medium, comprising:
a linearly movable carriage for holding said member;
a coating head for dispensing a composition onto said member;
curing means for (a) initially curing said composition film with an energy source at a primary energy flux density, and (b) secondarily curing said composition film with an energy source at a secondary energy flux density that is greater than said primary energy flux density.

35. A machine according to claim 34 wherein said curing means comprises:
a primary curing station for initially curing said composition film with an energy source at the primary energy flux density, said carriage being movable along a processing path past said coating head to said primary curing station.

36. A machine according to claim 35 comprising:
a secondary curing station for secondarily curing said composition film with an energy source at a secondary energy flux density that is greater than said primary energy flux density, said carriage being movable along said processing path past said coating head and said primary curing station to said secondary curing station.

37. A method of making a rotogravure printing medium which includes a member with a film coating that is selectively alterable to produce ink-retaining cells, wherein the method comprises the steps of:
depositing on the surface of the member a composition film of irreversibly curable plastic composition which is engraveable after curing to produce ink-retaining cells;
initially curing said composition film at a first station with an energy source at a primary energy flux density;
moving said composition film linearly to a second station: and
secondarily curing said composition film at said second station with an energy source at a secondary energy flux density that is greater than said primary energy flux density.

38. A method according to claim 37 wherein the step of depositing the coating is performed by:
depositing on the surface of the member a series of adjacent strip or bead portions of a self-leveling, irreversibly curable plastic composition which is engraveable after curing to produce ink-retaining cells, the adjacent strip or bead portions merging and self-leveling at and after deposition to produce a uniform, continuous coating of the plastic composition.

39. A method according to claim 37 wherein the step of initially curing is performed with said primary flux density at a magnitude sized to partially cure said composition film without surficially dimpling the composition film.

40. A method according to claim 39 wherein the step of initially curing is performed with said primary flux density at a magnitude sized to avoid forming a relatively hard shell upon the composition film.

41. A method employing a coating head for dispensing a composition on a roll in order to make a rotogravure printing medium which includes a film coating that is selectively alterable to produce ink-retaining cells, wherein the method comprises the steps of:
positioning said roll at said coating head in order to dispense said composition onto said roll with said coating head;
rotating said roll about its axis while translating said roll axially past said coating head; and
helically dispensing said composition onto said roll as a merging series of adjacent, self-leveling strip or bead portions, the adjacent strip or bead portions merging and self-leveling at and after deposition to produce a uniform, continuous coating of the plastic composition.

42. A method according to claim 41 comprising the steps of:
moving said roll away from said coating head;
initially curing said composition film with an energy source at a primary energy flux density; and
secondarily curing said composition film with an energy source at a secondary energy flux density that is greater than said primary energy flux density.

43. A method according to claim 41 comprising the step of:
heating said roll before depositing said composition from said coating head.

44. A method according to claim 43 comprising the step of:
continuing heating of said roll at said coating head.

45. A method according to claim 43 comprising:
moving said roll along a processing path past said coating head; and
initially curing said composition film with an energy source at a primary energy flux density.

46. A method according to claim 41 comprising the step of:
adjusting the proportionality between the flow rate of the composition through said coating head and the angular speed of said roll.

47. A method according to claim 41 comprising the step of:
moving said coating head along a discrete adjustment path that is radial relative to said roll to adjust for roll size.

48. A method according to claim 47 wherein said adjustment path extends at an acute angle to vertical.

49. A method according to claim 47 wherein said coating head has a tubular needle, the method including the steps of:
discretely adjusting the pitch and roll of said tubular needle.

50. A method according to claim 41 comprising the step of:
heating the composition flowing through said coating head.

51. A method according to claim 50 comprising the step of:
sensing and thermostatically controlling the temperature of said composition in said coating head.

52. A method according to claim 41 comprising the step of:
filtering the composition before passing it out of said coating head.

53. A method according to claim 52 comprising the step of:
sensing and displaying information about the pressure of said composition in said coating head.

54. A method according to claim 41 comprising the step of:
directing a stream of ionized air on said roll before depositing said composition on said roll.

55. A method according to claim 54 comprising the step of:
vacuum cleaning said roll after treatment by the ionized air and before depositing said composition on said roll.
